(19) United States
(12) Patent Application Publication
(10) Pub. No.: US 2016/0379441 A1
(43) Pub. Date: Dec. 29, 2016

(54) APPLICATION FOR ENHANCING A SPORT VIEWING EXPERIENCE ON AN ELECTRONIC DEVICE

(71) Applicant: Mark Oley, Glendora, CA (US)

(72) Inventor: Mark Oley, Glendora, CA (US)

(21) Appl. No.: 14/747,365

(22) Filed: Jun. 23, 2015

(51) Int. Cl. G07F 17/32

(52) U.S. Cl. CPC G07F 17/3241; G07F 17/3288; G07F 17/3209; G07F 17/3244; G07F 17/323

(57) ABSTRACT

The present invention relates to an application used for enhancing the sport viewing experience by instantly recognizing the player's performance and rewarding the player(s) based on the performance. Upon receiving a reward or recognition, the player can send an acknowledgment response to the rewarding user. Additionally, the application facilitates various features to enhance the sport viewing experience.

### FIELD OF THE INVENTION

The present invention generally relates to enhancing a sport viewing experience on an electronic device and more particularly relates to enhancing the sport viewing experience on an electronic device by instantly recognizing the player's performance.

### BACKGROUND OF THE INVENTION

The existing Mixed Martial arts (MMA) sport viewing mobile applications allow the users to view fighters profile statistics, basic fighter information with the option of a deeper description about the fighters, and facilitates a central place to buy all fighter merchandise, which a large portion goes to the fighters. Further, the applications allow the users to update and change the fighter's profile across the board on the entire application. However, the existing MMA sport viewing applications do not facilitate user's interaction with the player(s) participating in the MMA sport. At times, the users may want to appreciate the performance of the player(s) or disregard the performance of the player(s) while the sport is being played. As the existing sport viewing mobile applications do not facilitate interactivity aspect, the users will not be able to provide instant appreciation or comments for the players participating in the sport.

Hence, there is a need for an online shopping platform that can enhance the consumer's shopping experience by identifying the product to be purchased through a hand-held device and completing the transaction in a secure manner through the hand-held device.

### SUMMARY OF THE INVENTION

The present invention relates to an application for enhancing a sport viewing experience on an electronic device by instantly recognizing the player(s) performance in the sport streamed as a live video on an electronic device. The application is configured to register the user with the application and allows the registered user to select the player(s) performing in the sport based on the performance. Further, the application is configured to allow the registered user to instantly recognize an inciting performance of the player(s) in the sport by selecting the player(s) performing in a streamed live video. Further, the application is configured to receive an acknowledgement from the player(s) after the player(s) is/are recognized by the registered user. Additionally, the application supports a plurality of features to enhance the viewing experience of the sport streamed on the electronic device.

### BRIEF DESCRIPTION OF DRAWINGS

FIG. 1 illustrates a working overview of the system for instantly recognizing the player(s) performance in a sport streamed as a live video on an electronic device.

FIG. 2 illustrates various features facilitated by the application to enhance the sport viewing experience on the electronic device.

FIG. 3 illustrates a flow-chart that explains the process of instantly recognizing the player(s) performance in a sport.

FIG. 4 illustrates a system overview of components used for enhancing the sport viewing experience on the electronic device.

### FIGURE DESCRIPTION

100—A working overview of the system
101—An electronic device on which the application is installed
102—An application that allows the user to instantly recognize the player(s) performance
103a, 103b—Players of the sport
104—A button used for selecting the player(s) based on the performance
105—Application connected with the player(s) of the sport
201—A Digital Collecting card feature
202—A Collective judgement feature
203—A Sport simulation feature
204—An Event Scheduler feature
205—A Betting or trading feature
206—An Online Chatting feature
400—A System overview of components
401—An Application Interface module
402—A Digital Collecting Cards module
403—A Collective Judgement module
404—A Simulation module
405—An Event Scheduler module
406—A Betting/Trading module
407—An Online Chatting module
408—A Storage module
409—A Communication module
410—A Controlling module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, the term electronic device refers to a device that is capable of streaming a sport video and allowing the registered user to select a player when an inciting action is demonstrated by the player in the streamed sport video. For example, the electronic device can be a mobile device, a smart phone, a laptop, a tablet, a personal computer, or the like.

In an embodiment, a registered user registers himself/herself with the application that is installed on the user's mobile device. Through the application, the registered user can establish a communication channel with the player's electronic device and/or with the player's account to communicate or to sponsor/donate rewarding cash to the player(s) participating in the sport streamed as a live video. The term user in the document refers to the registered user.

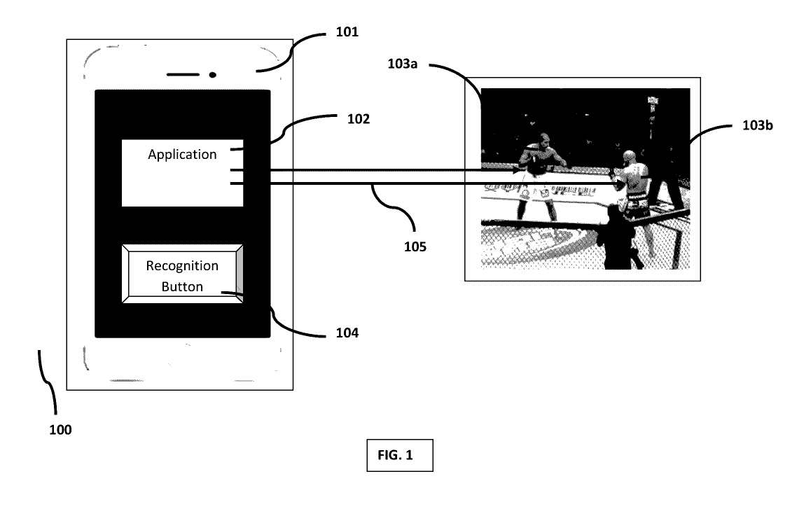

Referring to FIG. 1 illustrates a working overview of the system 100 for instantly recognizing the player(s) 103a, 103b performance in a sport streamed as a live video on an electronic device 101. As depicted in the figure, the registered user watches a live video of the sport on the electronic device 101 through the application 102. While watching the sport, the user may notice some inciting fighting styles and/or skills demonstrated by the player(s) 103a, 103b. As soon as the user notices the fighting styles and/or skills, he/she may want to appreciate the player(s) 103a, 103b instantly over the network. In an embodiment, the application 102 allows the user to recognize the player's performance by selecting the player(s) on the electronic device 101. The player(s) can be selected on the electronic device 101 by performing various gestures such as a tap, a swipe, a hover, or the like over the player(s) who is/are to be recognized. Upon selecting the player(s), the application 102 establishes a connection 105 with the player's electronic device 101, and the application 102 is configured to transfer a reward prize to the player's account when a recognition button 104 is pressed. In an embodiment, the application 102 can be configured to transfer the rewarding amount to the player's account through a third party payment system that is existing in the market. For example, the third party payment system can be PayPal, amazon.com, Escrow, or the like.

In an embodiment, the user can register with the application 102 by opting various types of registrations that are determined based on the registration fee paid by the user. Based on the type of registration availed by the user, the user can send a text message or a voice message to the player's electronic device 101 along with the reward prize through the application 102.

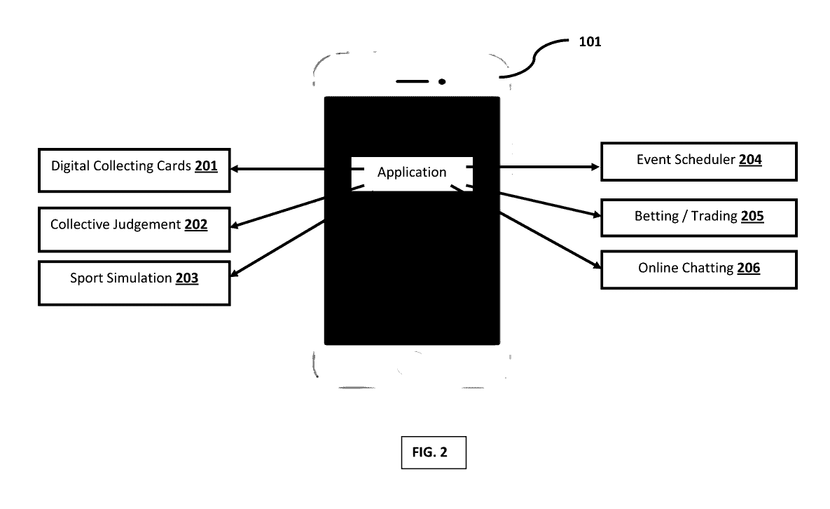

Referring to FIG. 2 illustrates various features facilitated by the application 102 to enhance the sport viewing experience on the electronic device 101. In an embodiment, the application 102 facilitates the following features to enhance the sport viewing experience: a Digital Collecting Cards 201, a Collective Judgement 202, a Sport Simulation 203, an Event Scheduler 204, a Betting/Trading 205, and an Online Chatting 206. The digital collecting cards 201 feature supported by the application 102 allows the user to collect various digital cards associated with the player(s). Further, the application 102 allows the user to customize, collect, play with the digital cards and enables the user to trade the digital cards online. In an embodiment, the collective judgement 202 feature supported by the application 102 allows multiple users to provide judgement for various actions or activities performed by the player(s) participating in the sport. Based on the judgement provided by the user(s), the application is configured to provide a collective judgement 202 for the player(s). Further, the collective judgement 202 determined for the player(s) participating in the sport can be shared with the player(s). In an embodiment, the sport simulation 203 feature supported by the application 102 can be configured to simulate the outcome of a fight based on various factors associated with the player(s), wherein the factors that determine the outcome of a fight includes but not limited to a fighter statistics, a weight of the fighter, a past fight history of the fighter, or the like. Further, the sport simulation 203 feature can also be used to create fictitious fighters for initiating a hypothetical match based on which the ranking system can be determined. In an embodiment, the Event scheduler 204 feature supported by the application 102 can be configured to schedule various MMA sport events. In an embodiment, the Betting/trading 205 feature supported by the application 102 can be configured to facilitate betting or trading of the digital collection cards within the network. In an embodiment, the Online chatting 206 feature supported by the application 102 facilitates exchanging of instant messages or text with various users regarding the sport that is streamed on the electronic device 101.

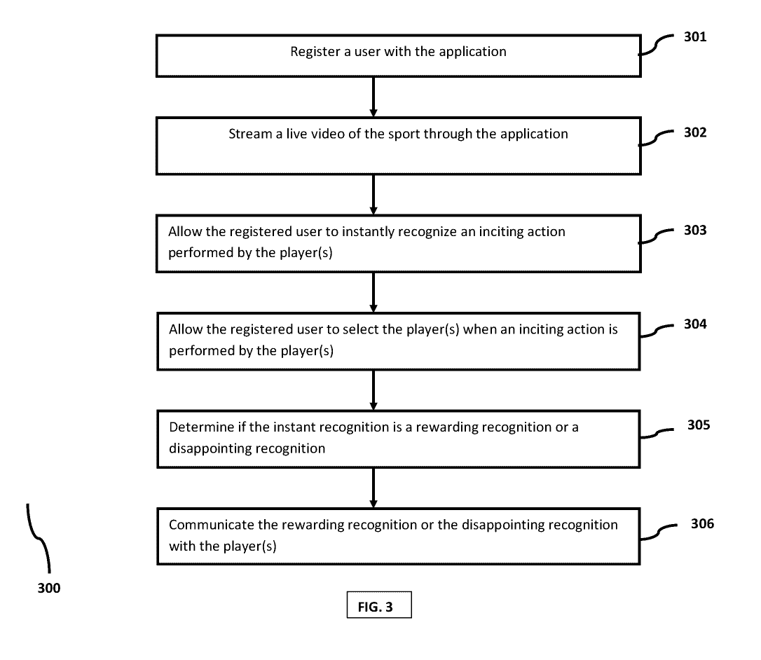

Referring to FIG. 3 illustrates a flow-chart 300 that explains the process of instantly recognizing the player(s) performance in a sport. Initially, at step 301, the user is registered with the application 102 installed on the electronic device 101. At step 302, the registered user is allowed to view the streamed sport through the application 102. At step 303, the user viewing the streamed sport instantly recognizes an inciting action demonstrated by the player(s) participating in the streamed sport. At step 304, as the user recognizes an inciting action demonstrated by the player(s) participating in the streamed sport, the application 102 allows the user to select the player(s) instantly for recognizing the player's performance. At step 305, the application 102 is configured to determine if the instant recognition of the player's performance is a rewarding recognition or a disappointing recognition. Further, based on the type of recognition identified for the player, at step 306, the application 102 is configured to reward or penalize the player(s). For example, if the player demonstrates an inciting fighting stroke then the application 102 allows the user to establish a communication channel with the player instantly and allows the user to reward the player through money or cash along with the message. However, if the player demonstrates a bad fighting stroke then the application 102 allows the user to establish a communication channel with the player instantly and allows the user to send penalizing comments to the player. In an embodiment, the application 102 allows the user to send the reward(s) and/or message(s) anonymously to the player(s) instantly while a live sport is being viewed by the user.

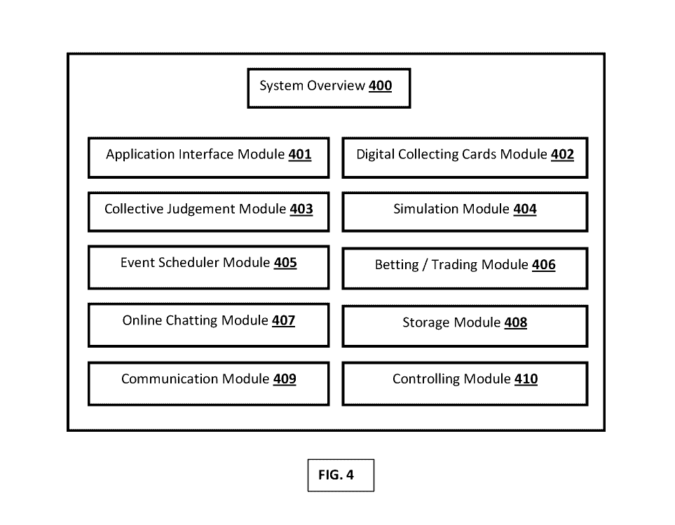

Referring to FIG. 4 illustrates a system overview 400 of components used to implement the method for enhancing the sport viewing experience on the electronic device 101, wherein the system comprises of the following components: an Application Interface module 401, a Digital Collecting Cards module 402, a Collective Judgement module 403, a Simulation module 404, an Event Scheduler module 405, a Betting/trading module 406, an Online Chatting module 407, a Storage module 408, a Communication module 409 and a Controlling module 410. In an embodiment, the Application Interface module 401 is configured install the application for instantly recognizing the player(s) performance in the sport. Further, the Application Interface module 401 is configured to allow the user to select the player(s) for instantly recognizing the player(s) performance. In an embodiment, the Digital Collecting Cards module 402 is configured to implement the Digital Collecting Cards feature as explained above. In an embodiment, the Collective Judgement module 403 is configured to implement the Collective judgement feature as explained above. In an embodiment, the Simulation module 404 is configured to simulate the sport and to determine the outcome of the simulated sport. In an embodiment, the Event Scheduler module 405 is configured to schedule one or more events for the sport. In an embodiment, the betting/trading module 406 is configured to facilitate trading or betting feature for the player(s) participating in the sport. In an embodiment, the Online chatting module 407 is configured to facilitate an online chatting session between users while viewing the sport on the electronic device 101. In an embodiment, the Storage module 408 is configured to store data or information associated with the player(s) such as the digital collection card. In an embodiment, the Communication module 409 is configured to establish a communication channel between the player(s) and the user for instantly recognizing the player's performance through the application 102. In an embodiment, the Controlling module 410 is configured to transfer data or information across various modules supported in the system 400.

1. An application for instantly recognizing at least one player performance in a sport streamed as a live video on an electronic device, wherein said application comprises of:
a means to register a user with said application;
a means to allow said registered user to select said at least one player performing in said sport based on the performance;
a means to allow said registered user to instantly recognize said at least one player performing is said sport by selecting said at least one player;
a means to receive an acknowledgement from said at least one player after said at least one player is recognized by said registered user; and
a means to support a plurality of features to enhance said sport facilitated on said electronic device.

2. The application as claimed in claim 1, wherein said application allows said registered user to select said at least one player performing in said sport by instantly identifying an inciting action exhibited by said at least one player.

3. The application as claimed in claim 2, wherein said application allows said registered user to select said at least one player's inciting action in said sport by recognizing a gesture performed by said registered user.

4. The application as claimed in claim 3, wherein said gesture performed by said at least one player can be one of: a button press, a finger swipe, a hover, a mouse click, a slide movement.

5. The application as claimed in claim 1, wherein instantly recognizing said at least one player performing in said sport can be either a rewarding recognition or a disappointing recognition.

6. The application as claimed in claim 5, wherein instantly recognizing said at least one player performing in said sport can be in the form of: transferring a cash price, sending an appreciation message, sending a disapproval message, sending a reward point, rising the review point, lowering the review point.

7. The application as claimed in claim 1, wherein said plurality of features facilitated for said sport streamed on said electronic device comprises of: a collection of digital cards, arranging an event scheduler, providing a collective judgement, providing a simulation of the sport.

8. The system for instantly recognizing at least one player performance in a sport streamed as a live video on an electronic device, wherein said system comprises of an Application interface module, a Digital collecting cards module, a Collective judgement module, a Simulation module, an Event scheduler module, a Betting/trading module, an Online Chatting module, a Storage module, a Communication module and is configured to:
register a user with said application by using said application interface module;
allow said registered user to select said at least one player performing in said sport, that is streamed live on said electronic device, based on the performance by using said application interface module;
allow said registered user to instantly recognize said at least one player performing is said sport by selecting said at least one player by using said communication module;
receive an acknowledgement from said at least one player after said at least one player is recognized by said registered user; and
provide a plurality of features to enhance said sport facilitated on said electronic device by using the following modules said Digital collecting cards module, said Collective judgement module, said simulation module, said Event scheduler module, said Betting/trading module, said Online Chatting module.

9. The system as claimed in claim 8, wherein said application allows said registered user to select said at least one player performing in said sport by instantly identifying an inciting action exhibited by said at least one player.

10. The system as claimed in claim 9, wherein said application allows said registered user to select said at least one player's inciting action in said sport by recognizing a gesture performed by said registered user.

11. The system as claimed in claim 10, wherein said gesture performed by said at least one player can be one of: a button press, a finger swipe, a hover, a mouse click, a slide movement.

12. The system as claimed in claim 8, wherein instantly recognizing said at least one player performing in said sport can be either a rewarding recognition or a disappointing recognition.

13. The system as claimed in claim 12, wherein said system is configured to instantly recognize said at least one player performing in said sport in the form of: transferring a cash price, sending an appreciation message, sending a reward point, rising the review point.

14. The system as claimed in claim 8, wherein said plurality of features facilitated for said sport streamed on said electronic device comprises of: a collection of digital cards, arranging an event scheduler, providing a collective judgement, providing a simulation of said sport, an online chatting session.
